(19) United States
(12) Patent Application Publication
(10) Pub. No.: US 2008/0265578 A1
(43) Pub. Date: Oct. 30, 2008

(54) METHOD FOR OPERATION OF A WIND ENERGY INSTALLATION AND A WIND ENERGY INSTALLATION

(76) Inventor: Matthias Stommel, Ganderkesee (DE)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/106,696

(22) Filed: Apr. 21, 2008

(30) Foreign Application Priority Data
Apr. 27, 2007 (DE) 102007020423.1

(51) Int. Cl. F03D 7/00; F03D 9/00

(52) U.S. Cl. 290/44

(57) ABSTRACT

The invention relates to a method for operation of a wind energy installation, having a rotor (18) which can be driven by the wind and has at least one rotor blade (22), and having at least one electrical/electronic component or an assembly composed of electronic/electronic components, for example a generator for conversion of the mechanical energy of the rotor (18) to electrical energy, electrical cables, electrical connections, electrical motors or the like. In order to monitor the operating states of the component/the assembly (24-32), electromagnetic radiation and/or magnetic fields and/or electrical fields, currents or voltages which is or are emitted in an uncontrolled manner by the component/the assembly (24-32) and/or is or are influenced in an uncontrolled manner by this component/the assembly (24-32) are/is recorded, in particular measured, by means of a suitable recording device, which is preferably at a distance from the component/the assembly (24-32), and are/is analyzed by means of an analysis device on the basis of one or more predetermined criteria such that any change in the operating state of the component/the assembly (24-32) can be identified.

### STATEMENT OF RELATED APPLICATIONS

This application is based on and claims priority on German Patent Application No. 10 2007 020 423.1 having a filing date of 27 Apr. 2007, which is incorporated herein by this reference.

### BACKGROUND OF THE INVENTION

1. Technical Field

The present invention relates to a method for operation of a wind energy installation, having a rotor which can be driven by the wind and has at least one rotor blade, and having at least one electrical/electronic component or an electrical/electronic assembly and, for example a generator for conversion of the mechanical energy of the rotor to electrical energy, electrical cables, electrical connections, electrical motors or the like. The invention also relates to a wind energy installation for carrying out this method, and to a system for monitoring said components/assemblies of a wind energy installation.

2. Prior Art

Electrical/electronic components/assemblies of wind energy installations are susceptible to disturbances. Malfunctions of these components/assemblies can lead to lengthy failures of the wind energy installations. In the worst case, shorts can cause fires in individual components or in the entire wind energy installation. There is therefore a major requirement to identify disturbances to electrical/electronic components/assemblies as early as possible in order to make it possible to react reasonably and to avoid long downtimes.

### BRIEF SUMMARY OF THE INVENTION

The object of the present invention is therefore to specify a method for operation of a wind energy installation, a corresponding wind energy installation and a system, by means of which it is possible to monitor the operating states of electrical/electronic components/assemblies of the installation in as reliable a manner as possible during operation.

This object is achieved by a method of the type mentioned initially having a rotor which can be driven by the wind and has at least one rotor blade, and having at least one electrical/electronic component or an assembly composed of electronic/electronic components, for example a generator for conversion of the mechanical energy of the rotor to electrical energy, electrical cables, electrical connections, electrical motors or the like, characterized in that, in order to monitor the operating states of the component/the assembly, electromagnetic radiation and/or magnetic fields and/or electrical fields, currents or voltages which is or are emitted in an uncontrolled manner by the component/the assembly and/or is or are influenced in an uncontrolled manner by this component/the assembly are/is recorded, in particular measured, by means of a suitable recording device, which is preferably located at a distance from the component/the assembly, and are/is analysed by means of an analysis device on the basis of one or more predetermined criteria such that any change in the operating state of the component/the assembly can be identified.

This object also is achieved by a wind energy installation having at least one rotor blade and having at least one electrical/electronic component or an assembly composed of electronic/electronic components, for example a generator for conversion of the mechanical energy of the rotor to electrical energy, electrical cables, electrical connections, electric motors or the like, characterized in that the wind energy installation has a system for monitoring the operating states of one or more electrical/electronic components or assemblies of a wind energy installation, for example a generator for conversion of the mechanical energy of the rotor of the wind energy installation to electrical energy, and/or electrical cables and/or electrical connections, and/or electric motors or the like, characterized in that the system has a recording device for recording, in particular measuring, electromagnetic radiation and/or magnetic fields and/or electrical fields, currents or voltages which is or are emitted in an uncontrolled manner in that the component/the assembly and/or is or are influenced in an uncontrolled manner by or this component/the assembly, as well as an analysis device, by means of which the recorded waves, fields, currents or voltages can be analysed on the basis of one or more predetermined criteria such that changes in the operating states of the component/the assembly can be identified.

This object also is achieved by a system for monitoring the operating states of one or more electrical/electronic components or assemblies of a wind energy installation, for example a generator for conversion of the mechanical energy of the rotor of the wind energy installation to electrical energy, and/or electrical cables and/or electrical connections, and/or electric motors or the like, characterized in that the system has a recording device for recording, in particular measuring, electromagnetic radiation and/or magnetic fields and/or electrical fields, currents or voltages which is or are emitted in an uncontrolled manner by that component/the assembly and/or which is or are influenced in an uncontrolled manner by that component/the assembly, as well as an analysis device, by means of which the recorded waves, fields, currents or voltages can be analysed on the basis of one or more predetermined criteria such that changes in the operating states of the component/the assembly can be identified.

Accordingly, in order to monitor the operating states of the electrical/electronic component and/or the electrical/electronic assembly, electromagnetic radiation and/or magnetic fields and/or electrical fields, currents or voltages which is or are emitted in an uncontrolled manner by the component/the assembly and/or is or are influenced in an uncontrolled manner by this component/the assembly are/is recorded, in particular measured, by means of a suitable recording device, which is preferably at a distance from the component/the assembly. The results then are/is analyzed by means of an analysis device on the basis of one or more predetermined criterion such that any changes in the operating states of the component and/or the assembly can be identified. The recording is preferably carried out during operation of the wind energy installation, preferably continuously or at specific, in particular periodic, time intervals.

The invention is based on the discovery that electrical/electronic components/assemblies emit uncontrolled electromagnetic radiation, that is to say electromagnetic waves, and/or magnetic fields and/or electrical fields, currents or voltages, or that the components/assemblies influence these above-mentioned physical phenomena, at least in an uncontrolled manner. The expressions “electrical/electronic component” and “electrical/electronic assembly” are used widely for the purposes of this application. The expressions include, in particular, all the components and assemblies, such as appliances, installations, cables, small components and the like, which are electrically operated, through which electric current flows, which generate electricity, or are used to pass on electricity.

In the following text, for simplicity and for combination, the term “component” is used exclusively both for the term “assembly” and for the term “component”.

The invention is also based on the discovery that the abovementioned waves, fields, currents or voltages which result from the component or are influenced by this component are dependent on the operating state of the respective component, that is to say are characteristic of the operating state. As soon as the monitored component is subject to any disturbances, these waves, fields, currents or voltages that are produced or influenced change. In this case, of course, a special case of such changes of the waves, fields, currents or voltages is an initial or renewed occurrence of them. The changes, in particular the initial or renewed occurrence, may be recorded and may be analysed by means of the analysis device. For example, in the event of a short, the location of the short emits an electromagnetic pulse, which is recorded and is associated with the damage location during the analysis process.

By way of example, in the course of the recording and/or analysis of the abovementioned waves, fields, currents or voltages, the frequency and/or the strength of an electromagnetic wave can be recorded and/or analysed, the magnitude of the measured magnetic field strength of a magnetic field, the magnitude and/or the frequency of a measured electrical disturbance voltage, or the like.

Preferably, the analysis can be used to determine which component of a plurality of components and/or what type of component is subject to a disturbance, or, in general, which component and/or which component type the change in the operating state can be associated with. In a further embodiment, it is possible to determine the nature of the component disturbance.

The abovementioned electromagnetic waves, the electrical or magnetic fields and the electric currents or electrical voltages are caused in an uncontrolled manner, that is to say not specifically. In fact, the invention relates to the recording of the abovementioned physical phenomena, which are the result of inherent characteristics of the electrical/electronic components, specifically the transmission of electromagnetic waves and/or the production of electrical/magnetic fields or electric currents or electrical voltages, or the influencing of such waves, fields, currents or voltages effectively as a by-product during operation in the said manner.

Every conductor through which current flows in its own right causes, as is known, a magnetic field which surrounds the conductor and in principle can be detected. Conductors through which alternating current flows cause electromagnetic waves which can likewise be detected. Various electrical/electronic components which are connected to electrical supply lines or to control lines cause effects in these lines. For example, they influence the supply or control voltages in that they produce disturbance voltages, or the like.

In this case, in one major embodiment of the invention, a suitable transmitter also transmits to the component electromagnetic waves in the direction of that component. These electromagnetic waves, for example microwaves or radio waves, may be influenced, that is to say changed by the electrical/electronic component.

The electromagnetic waves which are or can be influenced as a function of the operating state of the component may then be recorded by means of the recording device, which has at least one receiver for such waves, and may be analysed by means of the analysis device.

The abovementioned waves, fields, currents or voltages may be recorded by various recording devices. Electromagnetic radiation which is emitted by the respective electrical/electronic component and is passed from the component to the recording device without the use of cables can be recorded by a recording device which has a corresponding receiver for such electromagnetic radiation. The frequency of this radiation will frequently vary in the radio range. Radio receivers are accordingly preferably used. Microwave receivers are alternatively or additionally also frequently used.

If the aim is to detect waves, fields, currents or voltages in or on cables, this can be done, for example, by appropriate test equipment which is connected to the same electrical line network as the electrical/electronic component itself. In a simple form, this test equipment may be voltmeters, ammeters and/or ohmmeters. For example, it is possible for the component being monitored to produce radio-frequency and voltage changes within the supply lines to which the component is connected. These radio-frequency voltage changes can be detected using suitable measurement devices at various points on the supply lines.

In one particular embodiment of the invention, at least one actual value, which characterizes the recorded electromagnetic waves and/or magnetic fields and/or electrical fields, currents or voltages, is compared with a predetermined nominal value or a predetermined limit value in the course of analysis of the above-mentioned physical phenomena, and this analysis is used in particular to identify disturbances in the operating state of the respective component, for example shorts or the like. A characterizing actual value such as this may, for example, be the frequency and/or the strength of a recorded electromagnetic wave, the magnitude of a measured magnetic field strength of a magnetic field, the magnitude and/or the frequency of a measured electrical disturbance voltage or the like.

In a further embodiment of the invention, the predetermined nominal value is a reference value which characterizes the undisturbed operating state of the component.

This reference value can be determined during the course of a reference recording or reference measurement. In this case, the electromagnetic waves and/or magnetic fields and/or electrical fields, currents or voltages which are emitted from and/or are influenced by the component in the undisturbed state are recorded. The values recorded in this way are preferably used directly as reference values for subsequent measurements. In general, it is invariably possible to derive reference values from these recorded values. The critical factor is that the determined reference values depend directly or indirectly on the values recorded in the described manner.

The electromagnetic waves and/or magnetic fields and/or electrical fields, currents or voltages are preferably recorded continuously or at specific time intervals, and the recorded values—measured values—are stored, related to time, in a memory which in particular is associated with the analysis device. The values which have been stored related to time are preferably visualized on an appropriate time/value diagram, for example on a screen associated with the analysis device. The recorded values, which have been stored related to time, of the electromagnetic waves and/or magnetic fields and/or electrical fields, currents or voltages, can be analysed automatically such that short-term, medium-term or long-term trends or developments can be identified from the time profile of the recorded values. By way of example, an analysis such as this can be used to identify at an early stage whether the operating behaviour of the component is deteriorating. Future malfunctions can advantageously be identified at an early stage from the trends or developments.

Individual components of the wind energy installation are subjected to open-loop or closed-loop control as a function of the recorded electromagnetic waves and/or magnetic fields and/or electrical fields, currents or voltages, in particular as a function of the result of the comparison of the actual value, which characterizes the waves and/or magnetic and/or electrical fields, currents or voltages, with the nominal value or the limit value, and/or as a function of optionally identified trends in the recorded values. In this case, they are preferably switched on or off, or one or more electromagnetic, acoustic or electrical signals are produced.

As a person skilled in the field of the prior art will be aware, there are many feasible measures which can be initiated depending on the result of the comparison, and which are related to the operation of the wind energy installation. For example, after detection that a first component has failed, a second, redundant component can be activated, and takes over the functions of the first component.

In general, at least one operating parameter of the wind energy installation, for example the wind incidence angle of at least one rotor blade of the wind energy installation, can be set as a function of the analysis according to the invention of the recorded electromagnetic waves and/or magnetic and/or electrical fields, currents or voltages.

For example, as soon as the analysis reveals component disturbances, for example a short in or on the component, appropriate warning signals can be produced in one embodiment, and are preferably transmitted in the form of remote diagnosis and/or remote maintenance of the wind energy installation by means of a suitable long-distance data transmission device, for example a computer device connected to the Internet, to a remote receiver for such signals, for example to a second computer device.

It is expedient for the corresponding monitoring system according to the invention comprising a recording device and analysis device to be connected by means of a suitable data link to the actual open-loop and/or closed-loop control device for controlling operation of the wind energy installation, by means of which the various operating parameters of the wind energy installation, for example the wind incidence angle of the at least one rotor blade, are set during operation of the installation. The expression data link means any type of cable connection or wire-free link by means of which information can be transmitted from the monitoring system to the open-loop and/or closed-loop control device, and preferably in the other direction as well.

Disturbance messages are preferably transmitted via the data link from the monitoring system to the open-loop and/or closed-loop control device for the wind energy installation. Any component disturbance detected by the monitoring system can therefore be transmitted to the open-loop and/or closed-loop control device for controlling operation of the installation. Depending on the detected disturbance, the open-loop and/or closed-loop control device can then initiate appropriate measures. For example, the wind energy installation can be switched to a different operating mode, and in particular can be switched off and/or switched such that no current flows.

Data which represents operating states of the wind energy installation is preferably included in the analysis or evaluation according to the invention of the recorded electromagnetic waves and/or magnetic and/or electrical fields, currents or voltages, in particular the instantaneous rotation speed of the rotor, the instantaneous power of the wind energy installation or other such data items. This data can be made available to the monitoring system from the open-loop and/or closed-loop control device, preferably by this data being transmitted via the abovementioned data link.

### BRIEF DESCRIPTION OF THE DRAWINGS

Further features of the present invention will become evident from the attached dependent claims, from the following description of one preferred exemplary embodiment, and from the attached drawing, in which:

FIG. 1 shows an oblique side view of a wind energy installation which is being operated using the method according to the invention.

### DETAILED DESCRIPTION OF PREFERRED EMBODIMENTS

The drawing illustrates a wind energy installation 10 which has a pod 16, arranged on the top face of the tower, at the upper end of a vertical tower 14 which is arranged on horizontal ground 12. As a person skilled in the field of the prior art will be aware, there are a wide range of feasible embodiments for the detailed design of a tower 14 of a wind energy installation 10. The invention is not, of course, restricted to the truncated conical form of the tower 14 described in the drawing. For example, the tower 14 may also be in the form of a grid mast.

A rotor 18 is arranged at one end of the pod 16 facing the wind, and has a hub 20. Two rotor blades 22 are connected to the hub 20, with the rotor blade roots 23 of the rotor blades 22 being inserted into appropriate openings in the hub 20, and being connected to it in a known manner.

The rotor 18 rotates about an axis which is inclined slightly upwards with respect to the horizontal. As soon as wind strikes the rotor blades 22, the individual rotor 18 together with the rotor blades 22 rotates about the rotor axis. The rotor blades 22 cover a circular area during rotation. The relative positions of the individual rotor blades 22 with respect to the wind can be varied by means of an adjustment device, which is not illustrated but is known by those skilled in the prior art, that is to say the incidence angle of the rotor blades 22 with respect to the wind is adjustable. The motion energy of the rotor shaft is supplied via an electronic gearbox 24, which is arranged within the pod 16, to a generator 26, which is likewise arranged within the pod 16 and converts the motion energy to electrical power.

The electrical power is supplied via power cables 28 from the pod 16 via the tower 14 to a separate equipment building 29, in which the grid-system connection 30 is arranged. Appropriate open-loop/closed-loop control 32 is provided for open-loop/closed-loop control of the wind energy installation 10, and is arranged within the tower 14, in the area of its base.

In particular, the electronic gearbox 24, the generator 26, the electrical cables 28, the grid-system connection 30 and the open-loop/closed-loop control 32 are in each case electrical/electronic components whose operating states are monitored by means of the present invention. This is done in particular by making use of the fact that the components emit electromagnetic waves during operation unintentionally, often in the form of an undesirable “by-product”. The emitted electromagnetic waves are in this case characteristic of the respective operating state of the components 24-32.

A system, which is not illustrated, for monitoring the components 24-32 has a receiver, which is not illustrated, for these electromagnetic waves, specifically a radio receiver. The system also has an analysis device, by means of which the received waves can be analysed. For this purpose, by way of example, the analysis device may have a spectral analysis appliance as known from the prior art, as well as a suitable computer device.

The analysis uses the respectively recorded or received spectrum to determine which of the components 24-32 of the respectively measured radiation has originated from. On the other hand, the analysis device can determine whether/when the operating states for the components are subject to disturbances.

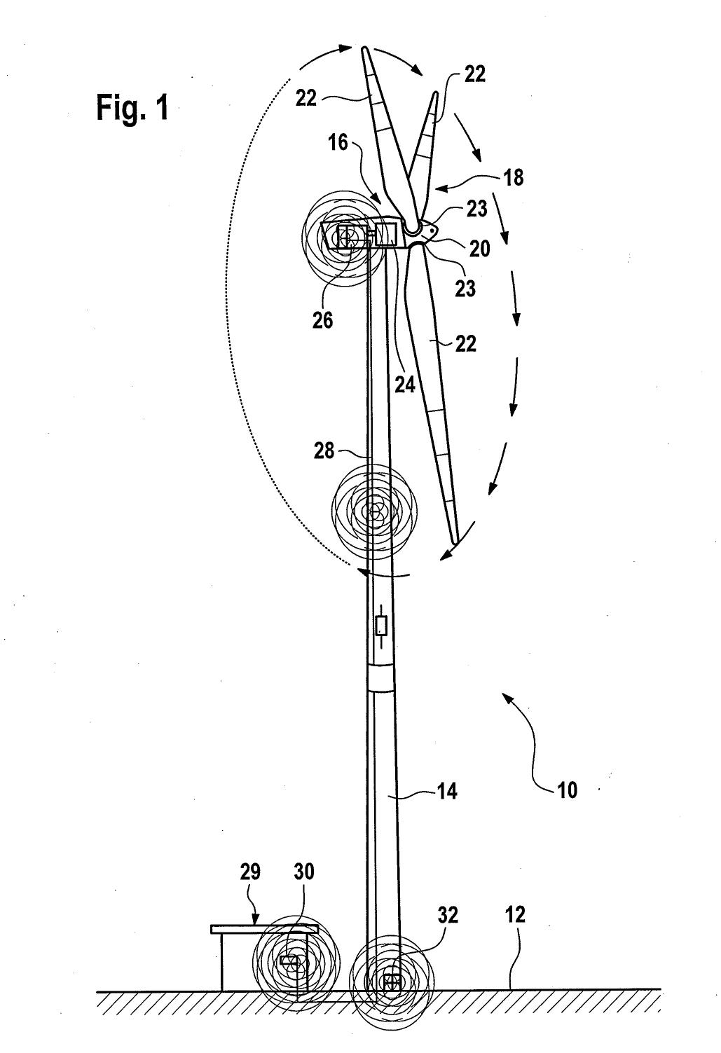

By way of example, FIG. 1 shows a crack in the cable line 28 in the middle of the tower 14. The crack in the cable line 28 leads to an electromagnetic pulse, which is detected and analyzed. The crack in the cable line is accordingly identified from the initial occurrence of a corresponding electromagnetic wave.

Disturbances of the other components 24-26, 30-32 are manifested in a time-dependent change in the spectrum of the respectively received electromagnetic radiation. In order to identify these disturbances, the analysis device in each case compares the measured spectra with reference spectra which are emitted from these components 24-26, 30-32 and have previously been determined during the course of previous reference measurements, and have been stored in a memory for the computer device of the analysis device.

In practice, the overall spectrum of the electromagnetic waves received by the radio receiver and emitted from the components 24-32 is recorded at specific time intervals or continuously over the entire spectral range of interest. The contributions of the individual components 24-32 to the overall spectrum are determined, and are associated with the individual components by means of the computer device for the analysis device, and are stored in a database.

Depending on which component 24-32 has resulted in a change in the operating state being identified and/or depending on the nature of the change in the operating state, different measures may be initiated.

For example, on detection of a short in the power cable 28, all the electrical/electronic components in the wind energy installation 10 are switched off, and/or are disconnected from voltage and/or are switched such that no current flows.

Changes in the operating state of the generator 26 or of the other components can lead to a suitable signal generating device, which is associated with the analysis device, generating suitable disturbance or warning messages.

There are many feasible options relating to this, as those skilled in the field of the prior art will be aware.

### LIST OF REFERENCE SYMBOLS

Wind energy installation
12 Ground
14 Tower
16 Pod
18 Rotor
20 Hub
22 Rotor blade
23 Rotor blade root
24 Gearbox
26 Generator
28 Power cable
29 Equipment building
30 Grid-system connection
32 Open-loop/closed-loop control

1. A method for operation of a wind energy installation, having a rotor (18) which can be driven by the wind and has at least one rotor blade (22), and having an assembly comprising at least one electrical/electronic component comprising:
measuring and recording electromagnetic radiation and/or magnetic fields and/or electrical fields, currents or voltages which is or are emitted in an uncontrolled manner by the assembly and/or is or are influenced in an uncontrolled manner by the assembly, in order to monitor the operating states of the assembly by means of a suitable recording device, and
analyzing the electromagnetic radiation and/or magnetic fields and/or electrical fields, currents or voltages by means of an analysis device on the basis of at least one predetermined criteria such that any change in the operating state of the assembly can be identified.

2. The method according to claim 1, wherein, during the course of the analysis for identification of disturbances in the operating state of the assembly is compared with a predetermined nominal value or a predetermined limit value, the at least one actual value being selected from the group consisting of values that characterize the recorded electromagnetic radiation, the magnetic fields, the electrical fields, the currents, and the voltages, and combinations thereof.

3. The method according to claim 2, wherein the predetermined nominal value is a reference value which characterizes the undisturbed operating state of the assembly.

4. The method according to claim 3, wherein the reference value depends on the at least one actual value determined during the course of a reference recording or reference measurement, and emitted from the undisturbed assembly and/or are influenced by the undisturbed assembly.

5. The method according to claim 2, wherein the at least one actual value is recorded continuously or at specific time intervals, and in that the recorded values are stored, related to time, in a memory which in particular is associated with the analysis device.

6. The method according to claim 5, wherein the recorded values which are stored, related to time of the at least one actual value are analyzed such that trends can be identified from the time profile of the recorded values.

7. The method according to claim 1, wherein electromagnetic radiation which originates from the assembly and characterizing the assembly itself and/or operating states of the assembly is recorded and is passed without the use of cables from the assembly to the recording device.

8. The method according to claim 1, wherein suitable electromagnetic waves which can be influenced by the assembly are transmitted to the assembly by means of a suitable transmitter which is at a distance from the assembly, and in that the electromagnetic waves which are influenced by the assembly are then recorded by the recording device.

9. The method according to claim 6, wherein individual components of the assembly of the wind energy installation are subjected to open-loop or closed-loop control as a function of the analysis of the comparison of the at least one actual value with the nominal value or the limit value, and/or as a function of the identified trends in the recorded values, by being switched on or off, or in that one or more electromagnetic, acoustic or electrical signals is or are produced.

10. The method according to claim 9, wherein data which represents operating states of the wind energy installation is recorded and is taken into account in the course of the analysis of the at least one actual value.

11. The method according to claim 9, wherein the wind energy installation is switched to a different operating mode as a function of the analysis.

12. The method according to claim 1, wherein the recording device has a receiver for electromagnetic waves.

13. A system for monitoring the operating states of at least one electrical/electronic components or assemblies of a wind energy installation, system comprising:
a recording device for recording, and/or measuring at least one actual value selected from the group consisting of values that characterize recorded, electromagnetic radiation, magnetic fields, electrical fields, currents, and voltages, and combinations thereof, which is or are emitted in an uncontrolled manner by the component or the assembly and/or which is or are influenced in an uncontrolled manner by the component or the assembly and
an analysis device for analyzing the at least one actual value on the basis of at least one predetermined criteria such that changes in the operating states of the component or the assembly can be identified.

14. A wind energy installation for carrying out the method according to claim 1, comprising at least one rotor blade,
at least one electrical/electronic component or an assembly composed of electronic/electronic components, and
a system according to claim 13.

15. The wind energy installation according to claim 14, wherein the system is connected by means of a data link to an open-loop and/or closed-loop control device for the wind energy installation, by means of which different operating parameters of the wind energy installation can be set in which data can be transmitted via the data link from the system to the open-loop and/or closed-loop control device.

16. The method according to claim 1, wherein the at least one electrical/electronic component or an assembly composed of electronic/electronic components comprises a generator for conversion of the mechanical energy of the rotor to electrical energy, electrical cables, electrical connections, and electrical motors.

17. The method according to claim 6, wherein the trends are any deterioration in the operating behaviour of the assembly and/or a future malfunction.

18. The method according to claim 8, wherein the suitable electromagnetic waves are radio waves or microwaves.

19. The method according to claim 10, wherein data which represents the operating states of the wind energy installation is selected from the group consisting of the instantaneous rotation of the speed of the rotor and the instantaneous power of the wind energy installation.

20. The method according to claim 11, wherein the wind energy installation is switched off and/or is switched such that no current flows.

21. The system according to claim 13, wherein the at least one electrical/electronic component or an assembly composed of electronic/electronic components comprises a generator for conversion of the mechanical energy of the rotor to electrical energy, electrical cables, electrical connections, and electrical motors.

22. The wind energy installation according to claim 14, wherein the at least one electrical/electronic component or an assembly composed of electronic/electronic components comprises a generator for conversion of the mechanical energy of the rotor to electrical energy, electrical cables, electrical connections, and electrical motors.

23. The wind energy installation according to claim 15, wherein the operating parameters of the wind energy installation is wind incidence angle of the at least one rotor blade.
